(19) United States
(12) Patent Application Publication
(10) Pub. No.: US 2004/0090403 A1
(43) Pub. Date: May 13, 2004

(54) Light-emitting diode display apparatus with low electromagnetic display

(75) Inventor: Ying-Chiun Huang, Chung-Li City (TW)

Correspondence Address: BANNER & WITCOFF, 1001 G STREET N W, SUITE 1100, WASHINGTON, DC, 20001, US

(73) Assignee: Dynascan Technology Corp., Taipei Hsien (TW)

(21) Appl. No.: 10/290,539

(22) Filed: Nov. 8, 2002

(51) Int. Cl. G09G 3/32

(52) U.S. Cl. 345/82

(57) ABSTRACT

A light-emitting diode display apparatus includes a diode string of a plurality of light-emitting diodes connected in series, a plurality of switch components each connected across a respective one of the light-emitting diodes, a voltage source that provides a working voltage to the diode string, and a current source that ensures flow of a constant current through assembly of the diode string and the switch components. Each switch component is independently controllable so as to operate in a selected one of an opened state, where the switch component permits current flow through the respective light-emitting diode, and a closed state, where the switch component prevents current flow through the respective light-emitting diode.

### BACKGROUND OF THE INVENTION

1. Field of the Invention

The invention relates to a light-emitting diode (LED) display apparatus, more particularly to an LED display apparatus with low electromagnetic radiation.

2. Description of the Related Art

Light-emitting diodes are electronic components that are driven to emit light by passing electric current therethrough. The magnitude of electric current through the light-emitting diode controls the intensity of the light emitted thereby. Light-emitting diodes are often used in displaying digits or images of an instrument, an electronic bulletin board, etc. As shown in FIG. 1, inside a conventional light-emitting diode (LED) display apparatus, a current limiting resistor 12 has one terminal coupled to a power source 1 and another terminal coupled to a light-emitting diode 2. The light-emitting diode 2 is further coupled to a collector 31 of a transistor 3. The transistor 3 has a base 32 connected to an input signal source 4 through a resistor 41, and further has a grounded emitter 33. The input signal source 4 provides a pulse-width-modulated signal to drive operation of the light-emitting diode 2. Referring to FIG. 2, the pulse-width-modulated signal (Vi) alternates between a constant drive current state and a zero state. The intensity of light emitted by the light-emitting diode 2 is adjusted by the varying the duty cycle of the pulse-width-modulated signal (Vi). Nevertheless, when the conventional LED display apparatus of FIG. 1 is applied to a large electronic bulletin board, the number of light-emitting diodes 2 required can reach up to several millions. Since each light-emitting diode 2 requires a corresponding drive circuit, the total drive current would be enormous and can reach as high as several hundreds or thousands of amperes. Moreover, the rapid change in the magnitude of the drive current results in the generation of strong electromagnetic interference (EMI) and can cause instability and complications in the design of the power supply system. Furthermore, even with light-emitting diodes of substantially uniform characteristics, since each light-emitting diode is driven by a respective drive current, each individual drive current has to be independently adjusted so as to result in homogenous intensity of a rendered image, which is a rather difficult task to accomplish.

### SUMMARY OF THE INVENTION

Therefore, the main object of the present invention is to provide a light-emitting diode display apparatus that is capable of overcoming the aforesaid drawbacks associated with the prior art.

Accordingly, the light-emitting diode display apparatus of this invention comprises:

a diode string including a plurality of light-emitting diodes connected in series;

a plurality of switch components, each of which is connected across a respective one of the light-emitting diodes and is independently controllable so as to operate in a selected one of an opened state, where the switch component permits current flow through the respective one of the light-emitting diodes, and a closed state, where the switch component prevents current flow through the respective one of the light-emitting diodes;

a voltage source coupled to the diode string and operable so as to provide a working voltage to the diode string; and

a current source coupled to the diode string and operable so as to ensure flow of a constant current through assembly of the diode string and the switch components.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit diagram illustrating a conventional LED display apparatus;

FIG. 2 is a schematic diagram showing a pulse-width-modulated signal for driving a light-emitting diode in the conventional LED display apparatus of FIG. 1; and

FIG. 3 is a schematic circuit diagram of a preferred embodiment of an LED display apparatus according to the present invention.

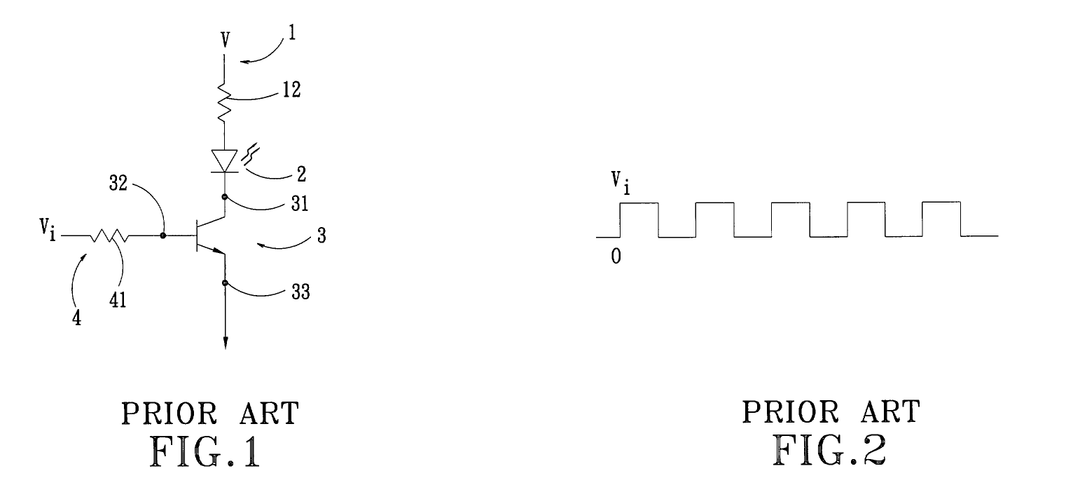

### DETAILED DESCRIPTION OF THE PREFERRED EMBODIMENT

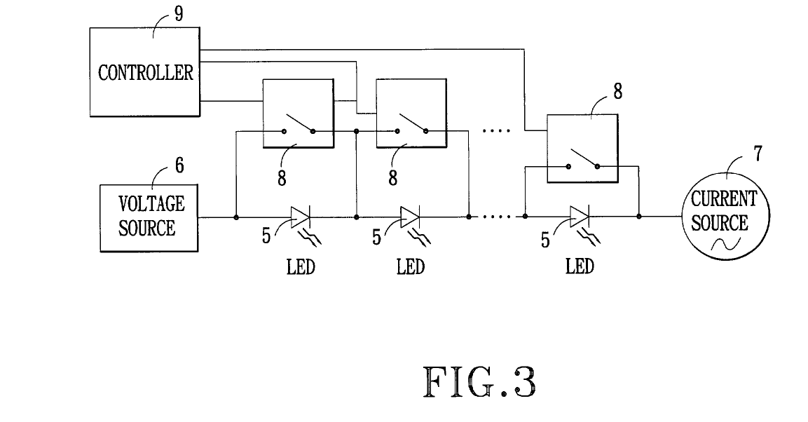

FIG. 3 illustrates a preferred embodiment of an LED display apparatus according to the present invention. The LED display apparatus is shown to include a diode string, a plurality of switch components 8, a voltage source 6, a current source 7, and a controller 9.

The diode string includes a plurality of light-emitting diodes 5 connected in series. Each of the switch components 8 is connected across a respective one of the light-emitting diodes 5 of the diode string, and is independently controllable so as to operate in a selected one of an opened state, where the switch component 8 permits current flow through the respective one of the light-emitting diodes 5, and a closed state, where the switch component 8 prevents current flow through the respective one of the light-emitting diodes 5. Each of the switch components 8 may be in the form of an electronic switch or a transistor, such as a field-effect transistor. The voltage source 6 is coupled to the diode string and is operable so as to provide a working voltage to the diode string. The current source 7 is coupled to the diode string and is operable so as to ensure flow of a constant current through assembly of the diode string and the switch components 8. In the preferred embodiment, the voltage source 6 and the current source 7 are coupled to opposite ends of the diode string. The controller 9 is coupled to the switch components 8 for controlling each of the switch components 8 to operate in the selected one of the opened and closed states.

In the LED display apparatus of FIG. 3, each light-emitting diode 5 relies on the voltage source 6 for the supply of the working voltage and on the current source 7 for the supply of a drive current. The controller 9 controls each of the switch components 8 to operate in the selected one of the opened and closed states. Since each of the switch components 8 is connected in parallel to the respective light-emitting diode 5, when the switch component 8 is opened by virtue of a control signal from the controller 9, the switch component 8 will work as an open circuit, where the drive current does not flow therethrough and instead flows through the respective light-emitting diode 5 so as to enable the latter to emit light. On the other hand, when the switch component 8 is closed by virtue of the control signal from the controller 9, the switch component 8 will work as a closed circuit, and since the resistance of the switch component 8 is very small at this time, most of the drive current will flow therethrough such that the respective light-emitting diode 5 will be unable to emit light.

To control the intensity of light emitted by a light-emitting diode 5, the duty cycle of the opened and closed states of the corresponding switch component 8 may be adjusted, such as with the use of the aforesaid conventional pulse width modulation technique.

Since the light-emitting diodes 5 are coupled in series, the working voltage is provided by the voltage source 6, and the drive current is provided by the current source 7, the drive current flows through the light-emitting diodes 5 whose corresponding switch component 8 is in the opened state, and does not flow through the light-emitting diodes 5 whose corresponding switch component 8 is in the closed state. Thus, flow of the constant drive current through the assembly of the light-emitting diodes 5 and the switch components 8 ensures that, when the light-emitting diodes 5 have substantially uniform characteristics, homogeneous intensity of a rendered image can be achieved. Moreover, since only one voltage source 6 and one current source 7 is used to drive all light-emitting diodes 5, there is no need for very large drive currents that can generate strong electromagnetic interference which destabilizes the power supply system.

While the presence of the switch components 8 in the LED display apparatus of this invention will involve additional costs, the added cost is minimal as compared to the total component cost of the LED display apparatus. Moreover, in consideration of the stability factor of the power supply system, the time and labor cost saving factor due to the need to maintain a single drive current source as compared to a plurality of drive circuits in the conventional LED display apparatus described beforehand will actually result in a reduction in operating costs.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. Alight-emitting diode display apparatus comprising:
a diode string including a plurality of light-emitting diodes connected in series;
a plurality of switch components, each of which is connected across a respective one of said light-emitting diodes and is independently controllable so as to operate in a selected one of an opened state, where said switch component permits current flow through the respective one of said light-emitting diodes, and a closed state, where said switch component prevents current flow through the respective one of said light-emitting diodes;
a voltage source coupled to said diode string and operable so as to provide a working voltage to said diode string; and
a current source coupled to said diode string and operable so as to ensure flow of a constant current through assembly of said diode string and said switch components.

2. The light-emitting diode display apparatus as claimed in claim 1, wherein said voltage source and said current source are coupled to opposite ends of said diode string.

3. The light-emitting diode display apparatus as claimed in claim 1, wherein each of said switch components is an electronic switch.

4. The light-emitting diode display apparatus as claimed in claim 1, wherein each of said switch components is a transistor.

5. The light-emitting diode display apparatus as claimed in claim 4, wherein said transistor is a field-effect transistor.

6. The light-emitting diode display apparatus as claimed in claim 1, further comprising a controller coupled to said switch components for controlling each of said switch components to operate in the selected one of the opened and closed states.
